(19) United States
(12) Patent Application Publication
(10) Pub. No.: US 2003/0054954 A1
(43) Pub. Date: Mar. 20, 2003

(54) Method for preparing a mesostructured material from particles with nanometric dimensions

(76) Inventors: Jean-Yves Chane-Ching, Eaubonne (FR); Frederic Cobo, La Courneuve (FR)

Correspondence Address: BURNS DOANE SWECKER & MATHIS L L P, POST OFFICE BOX 1404, ALEXANDRIA, VA, 22313-1404, US

(21) Appl. No.: 10/169,195

(22) PCT Filed: Dec. 29, 2000
(86) PCT No.: PCT/FR00/03756

(51) Int. Cl. C01F 17/00

(52) U.S. Cl. 502/304; 423/263

(57) ABSTRACT

The invention concerns a method for preparing a controlled mesoporous or mesostructured material, heat stable and at least partly crystallised, said method comprising steps which consist in: (A) forming an initial dispersion comprising: (1) at least partly crystalline colloidal particles of nanometric dimensions, whereof at least 50% of the population has a mean diameter ranging between 1 and 40 nm, and (2) a texturizer; (B) concentrating the resulting dispersion so as to obtain a solid by texturization and gradual aggregation of the colloidal particles; and (C) eliminating the texturizer in the resulting solid. The invention also concerns the partly crystalline and heat stable mesostructured products obtained by said method. The invention further concerns mesostructured materials, at least partly crystalline and heat stable, consisting essentially of a cerium, zirconium and/or titanium oxide. Said materials can be used in particular in catalysis.

The present invention relates to a process for preparing an heat-stable, ordered mesoporous or mesostructured, material with a high degree of crystallinity.

Within the strict meaning of the term, “mesoporous” materials are solids containing within their structure pores having a size that is intermediate between that of the micropores of materials of zeolite type and that of macroscopic pores.

More specifically, the expression “mesoporous material” originally denotes a material that specifically comprises pores with a mean diameter of between 2 and 50 nm, denoted by the term “mesopores”. Typically, these compounds are compounds of amorphous or paracrystalline silica type in which the pores are generally randomly distributed, with a very broad pore size distribution.

As regards the description of such materials, reference especially may be made to Science, Volume 220, pages 365-371 (1983) or to the Journal of Chemical Society, Faraday Transactions 1, Volume 81, pages 545-548 (1985).

On the other hand, “structured” materials are materials with an organized structure, which are characterized more specifically by the fact that they have at least one scattering peak in a radiation scattering diagram such as X-ray scattering or neutron scattering. Such scattering diagrams and the method for obtaining them are especially described in Small Angle X-Rays Scattering (Glatter and Kratky—Academic Press London—1982).

The scattering peak observed in this type of diagram may be associated with a repeat distance that is characteristic of the material under consideration, which will be denoted hereinbelow in the present description by the term “spatial repeat period” of the structured system.

On the basis of these definitions, the expression “mesostructured material” means a structured material with a spatial repeat period of between 2 and 50 nm.

Ordered mesoporous materials themselves constitute a special case of mesostructured materials. They are in fact mesoporous materials with an organized spatial arrangement of the mesopores present in their structure, and which actually have as a result a spatial repeat period associated with the appearance of a peak in a scattering diagram.

The family of materials of generic denomination “M41S”, described especially by Kresge et al. in Nature, Volume 359, pages 710-712 (1992) or by Q. Huo et al. in Nature, Volume 368, pages 317-321 (1994) constitutes the best known example of ordered mesostructured and mesoporous materials: they are silicas or alumino-silicates whose structure is formed of two- or three-dimensional channels ordered in a hexagonal (MCM-41) or cubic (MCM-48) arrangement, or alternatively which have a vesicular or lamellar structure (MCM-50).

It should be noted that, although they consist of a structure containing channels other than mesopores, the compounds known as MCM-41 and MCM-48 are generally described in the literature as being ordered mesoporous materials. For example, Fengxi Chen et al. effectively describe, in Chemical Materials, Volume 9, No. 12, page 2685 (1997), the channels present in these structures as “two- or three-dimensional mesopores”.

On the other hand, materials of vesicular or lamellar structure of MCM-50 type cannot themselves be likened to mesoporous structures, since their porous portions cannot be considered as mesopores. They will therefore be denoted solely by the term “mesostructured materials” in the rest of the description.

Ordered mesostructured and mesoporous materials of the type such as M41S are generally obtained by a process known as “liquid crystal templating”, usually denoted by the initials “LCT”. This “LCT” process consists in forming, from mineral precursors, a mineral matrix such as a silica or aluminosilicate gel in the presence of amphiphilic compounds of surfactant type.

The expression “liquid crystal templating” arises from the fact that it may be considered schematically that the liquid crystal structure initially adopted by the surfactant molecules sets the mineral matrix in its final shape.

Thus, it may be considered that, within the liquid crystal structure, the mineral precursors are located on the hydrophilic portions of the amphiphilic compounds before being condensed together, which gives to the mineral matrix finally obtained a spatial arrangement that is a copy of that of the liquid crystal. By removing the surfactant, e.g. by heat treatment or entrainment with a solvent, an ordered mesostructured or mesoporous material is obtained, which constitutes the imprint of the initial liquid crystal structure.

Beck et al. in The Journal of American Chemical Society, Vol. 114, p. 10834 (1992) thus explain the honeycomb structure of MCM-41 by the initial organization of the surfactant molecules in the form of a liquid crystal phase of hexagonal type.

It appears, however, as shown by Davis et al. in Microporous Materials, Vol. 2, p. 27 (1993) that the mechanism involved is a little more complex. In fact, it proceeds in a first stage by the formation of composite species consisting of micelles coated with mineral precursors that become organized, in a second step, into a hexagonal, cubic or lamellar network. However, the fact nevertheless remains that the final arrangement of the mineral matrix obtained is clearly governed by the initial shape of the micelles formed by the amphiphilic molecules used, which justifies the name “LCT” and the fact that the term “templating agent” is generally used to denote amphiphilic compounds of surfactant type used in this process.

Given their high specific surface area and their particular structure, the ordered mesostructured or mesoporous materials thus obtained are very advantageous, especially in the field of catalysis, absorption chemistry or membrane separation.

Nevertheless, in order to adapt them as best possible to these various applications, it was rapidly sought to modify them so as to improve their efficacy in these various fields.

Firstly, the structure of the material obtained had to be modified by varying the nature of the templating system used. Studies by Tanev et al., inter alia, have for example demonstrated the fact that the pore size depends on the length of the hydrophobic chain in the amphiphilic compounds used (Science, Vol. 267, pp. 865-867, 1995). However, they have above all shown that the passage from an ionic surfactant to an uncharged templating agent leads to a process known as “neutral templating”. This process induces a considerable increase in the thickness of the walls of the mesostructures, which leads especially to an improvement in the stability of the compound obtained.

However, in order to obtain mesostructured materials that are really advantageous, it is not sufficient to control these structural parameters alone. Specifically, the industrial development of mesostructured materials is currently conditioned by other imperatives regarding the very constitution of the mineral matrix, in particular its degree of crystallinity and the chemical nature of its constituents.

It should be pointed out that, in general, mesoporous materials typically consist of an amorphous or paracrystalline mineral matrix, of silica, alumino-silicate or alumina type. So as to improve the degree of crystallinity of these compounds, it has thus been envisaged to heat-treat the materials obtained. However, it should be noted that, although this heat treatment does indeed induce an increase in the crystallinity of the material, it also induces considerable embrittlement of the mesostructure, especially due to the reduction in the thickness of the walls, which may even lead in certain cases to collapse of the mesoporous structure during a rise in temperature.

Moreover, the attempts made to obtain crystalline mesoporous materials based on different constituents, for instance zirconium or titanium compounds, generally lead only to compounds of low stability, which prohibits their use on an industrial scale.

A sufficiently stable mesostructure can therefore currently be obtained only by using a limited number of chemical compounds, of silica and/or alumina type, with, in addition, a relatively low degree of crystallinity, which limits the potential uses of the materials obtained.

Now, although the process of liquid crystal templating usually uses mineral precursors that are specifically soluble, of silicate or alkoxide type in order for the templating to be really effective, the Inventors have now discovered, surprisingly, that the process of liquid crystal templating can, under certain conditions, be carried out using colloidal particles of nanometric size, without, however, affecting the efficacy of the templating.

The use of particles of this type in a process of liquid crystal templating has many advantages over the standard templating process.

Specifically, unlike mineral precursors of molecular type, these particles can have intrinsic structural properties that may be transmitted to the material obtained during the templating. Thus, it is envisaged, for example, that the templating of crystalline particles will lead directly to the production of a material that is at least partially crystalline, without a subsequent high-temperature crystallization treatment being necessary.

Furthermore, the use of particles that have intrinsic initial mechanical stability also makes it possible to form a stable material even with compounds, such as cerium oxide or zirconium oxide, which, according to the standard templating process, lead to compounds that are too brittle to be able to be exploited, especially at the industrial level.

On the basis of this discovery, the aim of the present invention is to provide a process for preparing materials with an ordered, stable mesostructured or mesoporous structure from particles of nanometric size.

A second aim of the invention is to provide mesostructured materials that moreover have a high degree of crystallinity.

Another aim of the invention is to incorporate into a mesoporous structure chemical compounds that have particular intrinsic properties, or alternatively particles of particular structures such as, for example, microporous structures, so as to give the material specific properties, without, however, affecting its stability.

One subject of the present invention is a process for preparing a heat-stable and at least partially crystalline ordered or mesostructured mesoporous material, said process comprising the steps consisting in:

(A) forming an initial dispersion comprising:

(1) colloidal particles of nanometric size, which are at least partially crystalline, at least 50% of the population of which has a mean diameter of between 1 and 40 nm; and

(2) a templating agent;

(B) concentrating the dispersion obtained so as to obtain a solid by templating and gradual consolidation of the colloidal particles; and

(C) removing templating agent from the solid obtained.

According to the present invention, an ordered or mesostructured mesoporous material is considered as heat-stable insofar as its mesostructure is conserved up to a temperature of at least 500° C. More specifically, a mesoporous material will generally be considered as heat-stable within the meaning of the invention insofar as, after calcination for 6 hours at 500° C., its specific surface area remains greater than 800 m² per cm³ of material. This specific surface area expressed in surface area units per unit volume of material is calculated by multiplying the experimental value of the specific surface area expressed in m²/g by the theoretical density (in g/cm³) of the chemical compound of which the material is composed.

Moreover, for the purposes of the invention, an “at least partially crystalline, ordered mesoporous or mesostructured” material denotes a material specifically having, in addition to order at the level of the mesostructure, an intrinsic crystallinity of the walls of this mesostructure.

For the purposes of the present invention, the expression “colloidal particles of nanometric size” means particles preferably of isotropic or spherical morphology, and at least 50% of the population of which has a mean diameter of between 1 and 40 nm, preferably between 3 and 15 nm and advantageously between 5 and 10 nm, preferably with a monodisperse particle size distribution. The use of particles with such a particle size leads to the production of mesostructured materials in which the size of the walls of the mesostructures is generally large, which especially gives the material high mechanical and heat stability.

Specifically, the colloidal particles of nanometric size used according to the present invention are at least partially crystalline particles, i.e. they have a degree of crystallinity ranging from 50 to 100% by volume. The use of these partially crystalline particles makes it possible to give the mesostructured materials obtained by the process of the invention a degree of crystallinity at least equal to 20% by volume.

In particular, these colloidal particles may also have, in addition to this crystallinity, a microporous structure, which then gives the material finally obtained both a mesoporous overall structure and, moreover, a microporous substructure.

Moreover, the colloidal particles used according to the invention preferentially consist of metal oxides, hydroxides or oxyhydroxides and may have at the surface a variety of chemical groups, especially nitrate or acetylacetonate groups or, particularly advantageously, OH⁻ groups in large proportion.

In particular, these particles of nanometric size are preferentially particles based on at least one compound of a metal chosen from cerium, zirconium and titanium. Thus, they may advantageously be particles consisting of cerium oxide CeO₂, zirconium oxide ZrO₂, titanium oxide TiO₂ or alternatively mixed particles of CeO₂/ZrO₂ or ZrO₂/CeO₂ type.

Colloidal particles of nanometric size of this type are well known to those skilled in the art and the methods for obtaining them have been widely described in the prior art. Thus, the cerium oxide colloidal particles used according to the invention correspond to particles of the type observed, for example, in the colloidal dispersions (cerium oxide sols) described especially in patent applications FR 2 416 867, EP 206 906 or EP 208 580. As regards zirconium oxide particles, reference may be made to the Journal of Gel Science Technology, Volume 1, page 223 (1994). Mention may also be made of the article in Chemical Materials, Volume 10, pages 3217-3223 (1998), as regards titanium oxide nanometric particles. The dispersions of mixed particles of CeO₂/ZrO₂ (in which the cerium is predominant) and ZrO₂/CeO₂ (in which the zirconium is predominant) type may themselves be obtained by thermal hydrolysis of partially neutralized mixed solutions of cerium nitrate and of zirconium nitrate, of the type described in patent applications EP 206 906 or EP 208 580.

In general, the particles of nanometric size used according to the invention are preferably introduced into the initial mixture in the form of a colloidal dispersion, advantageously an aqueous dispersion, the concentration of which is advantageously between 0.1 and 6 mol per liter and particularly preferably between 0.5 and 4.5 mol per liter.

The purity of these stock colloidal dispersions from which the suspension in step (A) is generally produced may be defined by comparing the electrical conductivity of the supernatant obtained by ultracentrifugation of said stock colloidal dispersion at 50 000 rpm for 10 hours, relative to the electrical conductivity of a control solution of HCl acid or of NaOH base having the same pH as the supernatant thus obtained.

On the basis of this definition, the supernatants obtained with suspensions used according to the process of the invention advantageously have a conductivity which is 200% less than the conductivity of the control solution, and preferentially 150% less than this control conductivity. These conductivity values correspond, specifically, to impurity concentrations that are low enough for the structure finally obtained not to be too embrittled due to the presence of foreign elements liable to inhibit the cohesion between the particles forming the material obtained. To obtain dispersions having such purities, it is especially possible to subject dispersions of the type described, for example, in patent applications EP 206 906 or EP 208 580 to an ultrafiltration treatment.

Moreover, the templating agent present in the dispersion in step (A) is an amphiphilic compound of surfactant type that can form micelles or phases of liquid crystal type in the reaction medium, so as to lead, by carrying out the “LCT” templating mechanism defined above, to the formation of a mineral matrix with an organized mesostructure.

Given the nature and size of the colloidal particles used and of the spatial arrangement of the mesoporous material that it is desired to obtain, a person skilled in the art can, by using simple routine measures, adapt the nature of this templating agent, especially as a function of the phase diagram presented by said templating agent under the implementation conditions of the invention.

However, in order to carry out a templating process that has the advantage of leading to suitable templating agent/particle interactions inducing in particular good stability of the final structure, the templating agent used in the process of the invention is advantageously a compound that is uncharged under the implementation conditions of the process.

Thus, in the case of an implementation of the process in acidic medium, in particular for a pH value of the initial dispersion of less than 4.5 and most particularly for a pH value of less than 3, the templating agent used according to the invention is preferably a nonionic surfactant of block copolymer type and more preferably a poly(ethylene oxide)-poly(propylene oxide)-poly(ethylene oxide) triblock copolymer known as PEO-PPO-PEO or (EO)ₓ-(PO)_{y}-(EO)_{z}, of the type described especially by Zaho et al. in Journal of the American Chemical Society, Volume 120, pages 6024-6036 (1998), and sold under the brand name Pluronic® by BASF. Advantageously, nonionic surfactants such as the grafted poly(ethylene oxide) (EO)ₓC_{y} products sold by Aldrich under the brand names Brij®, Tween® or Span®, or alternatively compounds of poly(ethylene oxide)-alkyl type, may also be used.

In the case of an implementation of the process in basic medium, in particular for a pH value of the initial dispersion of greater than 8, and most particularly for a pH value of greater than 9, the templating agent used is preferably a surfactant of primary alkylamine type such as, for example, decylamine, dodecylamine or tetradecylamine.

Moreover, in order to observe an efficient templating effect, the particles/templating agent ratio in the dispersion formed during step (A) is advantageously such that the (templating agent)/(templating agent+particles) volume ratio is between 0.36 and 0.70 and preferably between 0.40 and 0.65. In calculating this volume ratio, account is taken of the actual density of the colloidal particles used, which is generally less than the theoretical density of the material of oxide type of which said colloidal particles are composed.

It should also be pointed out that, in order to observe an efficient phenomenon of liquid crystal templating, the process is usually performed, especially in the case of the formation of a mineral matrix using a silica alkoxide, in a medium in which the (mineral precursor)-templating agent interactions are promoted.

In the case of the dispersions used according to the invention, the particle-templating agent interactions observed depend on the nature of the templating agent and on the particles used. In certain cases, these interactions may be sufficient in themselves and lead to a templating process of the neutral templating type described especially in Science, Volume 267, pages 865-867 (1995).

However, in order for sufficiently strong interactions to be observed within the starting suspension, the dispersion formed during step (A) often preferentially contains an “interaction” agent whose role is, as its name indicates, to increase the interaction between the templating agent and the colloidal particles.

The exact nature of this interaction agent is to be adapted as a function of the type of colloidal particles used and of the templating agent used. As such, the essential characteristic of the interaction agent is that it should lead, by intercalating between the particle and the templating agent, to the formation of a noncovalent bond, especially of hydrogen bonding, elecrostatic bonding or Van der Waals bonding type, by inducing overall an increase in the particle-templating agent interaction.

Thus, in the case of colloidal particles of cerium oxide, zirconium oxide or titanium oxide type preferentially used in the process of the invention, the interaction agent is advantageously a mineral or organic acid advantageously chosen from hydrochloric acid, nitric acid, sulfuric acid, phosphoric acid and acetic acid.

This type of acid, which may be represented schematically by H⁺X⁻, in which X⁻ is advantageously an ion chosen from halide ions such as, for example, chloride ions, or from the nitrate ion, the hydrogen sulfate ion, the sulfate ion, the hydrogenphosphate ion or the acetate ion, leads, in particular with nonionic templating agents of the type of the preferential templating agents of modified poly(ethylene oxide) type defined above, to bonds of (metal cation)—X⁻—H⁺—templating agent type which induce an effective increase in the overall particle-templating agent interaction.

In the case of the use of acid interaction agents of this type and of specific templating agents, the amount of acid interaction agent used so as to obtain an optimum interaction is advantageously such that the molar ratio (H⁺ ions)/(ethylene oxide monomers) is less than 0.3 and preferably less than 0.2.

The aim of step (A) of the process of the invention is thus to provide a suspension in which the particle-templating agent interactions are strong enough to initiate the templating process.

However, it should be pointed out that, despite the existence of these interactions, the templating process leading to the formation of the ordered mesoporous material only takes place, strictly speaking, during the concentration occurring during step (B).

Specifically, this concentration step leads to a gradual increase in the interactions, which finally leads to an effective templating of the colloidal particles.

In this respect, it should be noted that the suspensions formed during step (A) are aqueous suspensions advantageously containing a water-soluble cosolvent and preferentially having a low boiling point. The cosolvent/water volume ratio in the suspension is then advantageously less than or equal to 6 and preferentially less than or equal to 4.

This cosolvent is preferably an alcohol, advantageously chosen from methanol, ethanol, propanol and isopropanol.

As a result, the suspensions formed during step (A) are preferentially aqueous-alcoholic dispersions.

The role of the cosolvent used in the process of the invention is complex. Nevertheless, it may be indicated, in a nonlimiting manner, that the cosolvent may especially make it possible, depending on the case, to avoid excessive capillary stresses from being exerted during step (B) of concentration and formation of the mesoporous material. The cosolvent may also facilitate, by means of its low boiling point, step (B) of subsequent concentration, especially in the case where it is carried out by evaporation.

In practice, the order of addition of the various constituents of the suspensions of step (A) is not critical. However, advantageously, the colloidal particles are generally first introduced in the form of an aqueous suspension to which is added, where appropriate, the interaction agent, followed by incorporation of the templating agent with stirring, the optional addition of the cosolvent preferentially taking place in a final step.

Moreover, step (A) of forming the suspension is generally performed at ambient temperature, i.e. at a temperature advantageously between 15° C. and 35° C.

Step (B) of concentrating the suspension obtained during step (A) may be performed according to any means known to those skilled in the art. Its aim is to lead to the formation of the mesoporous structure by templating the colloidal particles and gradually consolidating the mesostructure obtained.

Nevertheless, so as not to embrittle the mesoporous structure during formation, this concentration step is preferentially performed by evaporation, which has the advantage of leading to a gradual concentration of the species present.

This evaporation may be carried out according to any means known in the prior art. It may thus especially be performed under atmospheric pressure, under partial vacuum or under flushing with gas, for example while flushing with air or nitrogen. It is also possible to work under a controlled partial pressure of water. Moreover, this evaporation may be performed in a single step at a given temperature, or in several steps then consisting of several successive evaporations with increasing temperature stages. These evaporation steps at the required temperature may be carried out especially in a stove, or alternatively in a suitable industrial installation of the type such as a dryer or atomizer.

When the concentration step is carried out in a single step, the evaporation temperature is generally between 15° C. and 80° C. and preferably between 20° C. and 60° C. The dispersion in step (A) can then be brought to the evaporation temperature either by a gradual increase in temperature with a temperature rise profile of between 0.1 and 6° C. per minute, or by placing it directly in a heated medium such as a stove brought beforehand to the evaporation temperature. The evaporation time is to be adapted as a function of the particles, the templating agent and the medium of the initial suspension, and is generally between 3 hours and 7 days.

When the concentration step is carried out in several steps, the temperature of the various successive stages is generally between 15° C. and 120° C. and preferably between 20° C. and 80° C. The duration of each of the stages is itself also to be adapted as a function of the particles, the templating agent and the medium of the initial suspension. It can range between a few hours and a few days, preferably between 3 hours and 24 hours. The temperature-rise steps may be carried out with a temperature rise gradient of between 0.1 and 6° C. per minute, or by passing directly into a heated medium such as a stove brought beforehand to the temperature of the stage. Thus, it is possible, for example, initially to perform a stage at 20° C., and then to carry out a direct rise to 80° C. by stoving and then to perform a second stage at this temperature of 80° C.

After this concentration step (B), the product advantageously has a water content of less than 500% by mass, preferably less than 200% by mass and particularly preferably between 0.1% and 100% by mass.

The material obtained may then be cooled to room temperature. Said material generally has the mechanical stability required to be optionally transferred, for example into a calcination crucible.

In order to obtain a material of mesoporous structure, the solid obtained after step (B) is then subjected to step (C) of removing the templating agent.

This step may be performed especially by entrainment with a solvent. It should be noted in this respect that the entrainment with a solvent is facilitated by the fact that an uncharged amphiphilic compound is preferentially used, which induces an interaction between the templating agent and the material that is weak enough to allow this type of removal.

However, in a particularly advantageous manner, this step (C) of removing the templating agent is performed by a heat treatment of calcination type. Specifically, in addition to the removal of the templating agent and the other organic compounds that may be present in the solid, this type of heat treatment moreover allows a reinforcement of the cohesion of the network of particles forming the material. In this case, this calcination is generally performed under nitrogen or air and at a temperature that is sufficient to remove the organic compound(s) present in the solid obtained and to improve the cohesion of the material. Thus, advantageously, the heat treatment is generally carried out at a temperature above 200° C. and preferably at a temperature above 350° C. The rate of temperature increase is then generally between 0.2° C. and 5° C. per minute and preferably between 0.5° C. and 2.5° C. per minute. This temperature increase is followed by a calcination stage generally lasting between 0.5 and 10 hours and advantageously between 1 and 6 hours.

According to a second aspect, the subject of the present invention is also the heat-stable and at least partially crystalline ordered or mesostructured mesoporous materials obtained according to the process described above.

Given the specific use of at least partially crystalline particles in their production, the materials of the invention generally have in their walls a degree of crystallinity of greater than 20% by volume. Advantageously, this degree of crystallinity may be greater than 30% by volume, or even 50% by volume. It may be even be possible according to the process of the present invention to produce materials that, in certain cases, have a degree of crystallinity of at least 90% by volume.

This crystallinity of the materials of the invention may especially be demonstrated by comparing the results obtained by X-ray scattering relative to the results observed with perfectly crystalline control samples. In this type of X-ray scattering diagram, if scanning is carried out in a sufficient wavelength range, the double level of order of the materials of the invention may be seen to appear. Specifically, the X-ray scattering diagrams obtained with the mesostructured and partially crystalline materials of the invention have, on the one hand, peaks corresponding to repeat periods of the order of a few angstroms, characterizing the intrinsic crystallinity of the crystal networks present in the walls, and, on the other hand, peaks characteristic of the spatial repeat period of the mesostructure, of between 2 and 50 nm.

The intrinsic crystallinity of the walls may also be observed by high-resolution transmission electron microscopy.

Moreover, electron microscopy makes it possible to determine the structure of the mesoporous materials of the invention.

Advantageously, the ordered or mesostructured mesoporous materials of the present invention are solids at least locally having one or more mesostructure(s) chosen from:

mesoporous mesostructures of three-dimensional hexagonal symmetry P63/mmc, of two-dimensional hexagonal symmetry P6 mm, or of three-dimensional cubic symmetry la3d, lm3m or Pn3m;

mesostructures of vesicular or lamellar type; or

mesostructures of L3 symmetry, known as sponge phases.

As regards the definition of these various symmetries and structures, reference may be made especially to Chemical Materials, Volume 9, No. 12, pages 2685-2686 (1997) or to Nature, Volume 398, pages 223-226 (1999), and, as regards the mesostructures known as sponge phases, to the article by McGrath et al. in Science, Volume 277, pages 552-556 (1997).

The repeat periods of the mesostructures present in the materials of the invention are generally of the order of 3 to 50 nm. Preferably, they are between 4 and 30 and advantageously between 5 and 20. In the specific case of ordered mesoporous structures, the pores observed are generally such that at least 50% of the population of the pores present in the structure has a mean diameter of between 2 and 10 nm.

Especially, given the specific use of particles with a mean size of the order of 1 to 40 nm in the preparation process, the mean thickness of the walls of the mesostructures of the materials of the invention is generally high. Thus, this mean wall thickness is generally at least of the order of the size of the particles used in the process and it is, consequently, generally between 2 and 40 nm. Advantageously, it is between 3 and 15 nm, and even more advantageously this mean thickness is between 4 and 10 nm which especially gives the material obtained high mechanical stability.

As regards the heat stability of the mesostructured materials of the invention, it should be noted that after calcination for a duration of 6 hours at 500° C., their specific surface area generally remains greater than 800 m²/cm³. Advantageously, it may even be greater than 1000 m²/cm³ and, in certain cases, it may reach values of greater than 1400 m²/cm³.

The materials of the present invention preferentially consist of cerium oxide, zirconium oxide, titanium oxide or a mixture of these compounds. Thus, the process of the present invention makes it possible to obtain novel materials that are mesostructured, and also partially crystalline and heat-stable, and composed essentially of cerium oxide, zirconium oxide, titanium oxide or a mixture of these compounds, especially a mixture of the type CeO₂/ZrO₂ or ZrO₂/CeO₂, and which have never been described in the prior art.

The expression “partially crystalline” means that these mesoporous materials have a degree of crystallinity greater than 20% by volume, advantageously greater than 30% by volume and in a particularly preferable manner greater than 50% by volume.

Moreover, the expression “material composed essentially of a cerium oxide, zirconium oxide and/or titanium oxide” specifically means, for the purposes of the present invention, a material consisting of more than 95%, advantageously of more than 97% and particularly preferably of more than 98% by mass of a cerium oxide, zirconium oxide and/or titanium oxide.

Furthermore, it should be noted that these materials essentially composed of a cerium oxide, zirconium oxide and/or titanium oxide are compounds that specifically contain no additional elements introduced so as to provide the material with cohesion. In particular, the materials composed essentially of a cerium oxide, zirconium oxide and/or titanium oxide within the meaning of the present invention are not materials comprising a mineral phase of silica or alumina type acting as binder between particles of cerium oxide, zirconium oxide and/or titanium oxide.

Moreover, it should be noted that the general principle of the process of the present invention may be applied to many types of colloidal particles. It should thus be pointed out that the materials obtained according to the process of the present invention are therefore not limited to these particular compounds consisting of cerium oxide, zirconium oxide and/or titanium oxide.

Given their high crystallinity, their mesoporous structure, the integration of advantageous metallic elements into their structure, and their relatively high heat stability, the materials of the present invention have many potential applications, especially in the field of catalysis, in particular in the field of motor vehicle depollution or the denitrification of effluents.

The illustrative examples described below relate to the preparation of mesostructured materials according to the invention, obtained by structuring cerium oxide particles of nanometric size.

### EXAMPLE 1

Step 1: Preparation of an aqueous colloidal dispersion of cerium oxide particles of nanometric size.

A cerium hydrate that is redispersible in water was prepared according to the procedure described in Example 1 of patent application EP 208 580. The CeO₂ content of the hydrate thus prepared is 68.57% by mass.

200 g of demineralized water were then added to 250 g of the cerium hydrate thus obtained, followed by dispersion using an UltraTurrax blender. The dispersion was centrifuged for 15 minutes at a speed of 45 000 rpm. A wet pellet of 240 g was then recovered. A further 180 g of water were added to this wet pellet, the total volume of the dispersion after addition of water being 250 ml. After rehomogenizing using the UltraTurrax blender, this colloidal dispersion, which is clear to the eye, was washed with 650 ml of water and then concentrated by passing through a 3 kD ultrafiltration membrane.

A colloidal dispersion of perfectly crystalline CeO₂ particles of nanometric size with a mean diameter of 5 nm was thus obtained.

On an aliquot of the dispersion thus obtained, the final CeO₂ concentration of the dispersion, determined by stoving and calcination, was 4M CeO₂. Moreover, the density of the dispersion was 1.67 g/cm³.

Another aliquot of the dispersion was subjected to an ultracentrifugation at 50 000 rpm for 6 hours. A clear supernatant was collected. By acid-based assay, a free acidity of 0.09 M was determined. The molar ratio (H⁺/Ce) in the prepared suspension was thus 0.0225. After diluting the ultracentrifugation supernatant fourfold, a conductivity equal to 9.22 mS/cm was determined.

Step 2: Preparation of the Mesostructured Material.

(A) 8.74 g of pure Prolabo methanol and then 2 g of 0.05M hydrochloric acid solution were poured into a beaker, followed by addition of 1 g of Pluronic® P123 to the mixture obtained. This compound Pluronic P123 is a surfactant of triblock block copolymer type obtained from the company BASF, having the empirical formula HO(CH₂CH₂O)₂₀(CH₂CH₃COH)₇₀(CH₂CH₂O)₂₀H and an average molecular mass equal to 5750 g/mol. The mixture thus prepared was stirred for 5 minutes. 8.26 g of the colloidal dispersion of CeO₂ prepared above were then added instantaneously and stirring was continued for 15 minutes.

(B) The dispersion obtained was then placed in a glass Petri dish 8 cm in diameter and was subjected to evaporation at 20° C. overnight under a fume hood.

(C) The dry product obtained was then transferred into an oven brought to 80° C. beforehand. The heat treatment at 80° C. was carried out for 16 hours. The product was then calcined at a temperature of 500° C., with a temperature rise of 10C/min and a stage at 500° C. of 6 hours.

Observation by transmission electron microscopy of the material obtained after these various steps reveals the existence of a mesostructure of hexagonal type.

The specific surface area of the material was determined to be equal to 170 m²/g, i.e. 1224 m²/cm³.

Moreover, the mean pore size determined by BET is 3.8 nm.

### EXAMPLE 2

(A) 8.74 g of water and then 2 g of 0.05M hydrochloric acid solution were poured into a beaker, followed by addition of 1 g of Pluronic P123 copolymer obtained from the company BASF. The mixture thus obtained was stirred for 25 minutes. 8.26 g of the colloidal dispersion of CeO₂ prepared in step 1 of Example 1 were then added instantaneously and stirring was continued for 15 minutes.

(B) The dispersion obtained was then placed in a glass Petri dish 8 cm in diameter and was subjected to evaporation at 20° C. overnight under a fume hood.

(C) The dry product obtained was then transferred into an oven brought to 35° C. beforehand. The heat treatment at 35° C. was carried out overnight. The product was then transferred into another oven brought to 80° C. beforehand. This second heat treatment at 80° C. was carried out for 16 hours. The material obtained was then subjected to a temperature of 500° C., with a temperature rise of 1° C./min and a stage at 500° C. of 6 hours.

Observation by transmission electron microscopy of the material obtained after these various steps reveals the existence of a mesostructure of hexagonal type.

The specific surface area of the material obtained is equal to 130 m²/g, i.e. 936 m²/cm³.

### EXAMPLE 3

(A) 8.74 g of water and then 2 g of 0.05M hydrochloric acid solution were poured into a beaker, followed by addition of 1 g of Pluronic P123 copolymer obtained from the company BASF. The mixture thus obtained was stirred for 25 minutes. 6.64 g of the colloidal dispersion of CeO₂ prepared in step 1 of Example 1 were then added instantaneously and stirring was continued for 15 minutes.

(B) The dispersion obtained was then placed in a glass Petri dish 8 cm in diameter and was subjected to evaporation at 60° C. for 72 hours in an oven.

(C) The dry product obtained was then transferred into a crucible and calcined at a temperature of 500° C., with a temperature rise of 10C/min and a stage at 500° C. of 6 hours.

Observation by transmission electron microscopy of the material obtained after these various steps reveals the existence of a mesostructure of hexagonal type.

The specific surface area of the material obtained is equal to 135 m²/g, i.e. 972 m²/cm³.

### EXAMPLE 4

(A) 8.74 g of ethanol and then 2 g of 0.25M hydrochloric acid solution were poured into a beaker, followed by addition of 1 g of Pluronic P123 copolymer obtained from the company BASF. The mixture thus obtained was stirred for 25 minutes. 6.64 g of the colloidal dispersion of CeO₂ prepared in step 1 of Example 1 were then added instantaneously and stirring was continued for 15 minutes.

(B) The dispersion obtained was then placed in a glass Petri dish 8 cm in diameter and was subjected to evaporation at 20° C. for 72 hours under a fume hood.

(C) The dry product obtained was then transferred into a crucible and calcined at a temperature of 500° C., with a temperature rise of 1° C./min and a stage at 500° C. of 6 hours.

Observation by transmission electron microscopy of the material obtained after these various steps reveals the existence of a mesostructure of hexagonal type.

The specific surface area of the material obtained is equal to 130 m²/g, i.e. 936 m²/cm³.

1. A process for preparing a heat-stable and at least partially crystalline ordered or mesostructured mesoporous material, said process comprising the steps consisting in:
(A) forming an initial dispersion comprising:
(1) colloidal particles of nanometric size, which are at least partially crystalline, at least 50% of the population of which has a mean diameter of between 1 and 40 nm; and
(2) a templating agent;
(B) concentrating the dispersion obtained so as to obtain a solid by templating and gradual consolidation of the colloidal particles; and
(C) removing templating agent from the solid obtained.

2. The process for preparing an ordered or mesostructured mesoporous material as claimed in claim 1, characterized in that said colloidal particles of nanometric size are particles of isotropic or spherical morphology, at least 50% of the population of which has a mean diameter of between 3 and 15 nm, with a particle size distribution of these particles that is preferably monodisperse.

3. The process for preparing an ordered or mesostructured mesoporous material as claimed in claim 1 or claim 2, characterized in that said colloidal particles are particles of isotropic or spherical morphology, at least 50% of the population of which has a mean diameter of between 5 and 10 nm, with a particle size distribution of these particles that is preferably monodisperse.

4. The process for preparing an ordered or mesostructured mesoporous material as claimed in any one of claims 1 to 3, characterized in that said colloidal particles of nanometric size have a degree of crystallinity ranging from 50% to 100% by volume.

5. The process for preparing an ordered or mesostructured mesoporous material as claimed in any one of claims 1 to 4, characterized in that said colloidal particles of nanometric size are introduced into the initial mixture in the form of a stock dispersion with a concentration between 0.1 and 6 mol per liter.

6. The process for preparing an ordered or mesostructured mesoporous material as claimed in claim 5, characterized in that the electrical conductivity of the supernatant obtained by ultracentrifugation at 50 000 rpm for 10 hours of said stock dispersion containing the colloidal particles is 200% less than the conductivity of a control solution of HCl acid or of NaOH base having the same pH as the supernatant thus obtained.

7. The process for preparing an ordered or mesostructured mesoporous material as claimed in any one of claims 1 to 6, characterized in that said colloidal particles of nanometric size are particles based on at least one compound of a metal chosen from cerium, zirconium and titanium, preferably chosen from particles of cerium oxide CeO₂, zirconium oxide ZrO₂, titanium oxide TiO₂ or mixed particles of CeO₂/ZrO₂ or ZrO₂/CeO₂ type.

8. The process for preparing an ordered or mesostructured mesoporous material as claimed in any one of claims 1 to 7, characterized in that the medium of the dispersion formed during step (A) is an acidic medium and in that the templating agent used is a nonionic surfactant of block copolymer type preferably chosen from poly(ethylene oxide)-poly(propylene oxide)poly(ethylene oxide) triblock copolymers and grafted poly(ethylene oxide) copolymers.

9. The process for preparing an ordered or mesostructured mesoporous material as claimed in any one of claims 1 to 7, characterized in that the medium of the dispersion formed during step (A) is a basic medium and in that the templating agent used is a surfactant of primary alkylamine type.

10. The process for preparing an ordered or mesostructured mesoporous material as claimed in any one of claims 1 to 9, characterized in that the (templating agent)/(templating agent+particles) volume ratio is between 0.36 and 0.70.

11. The process for preparing an ordered or mesostructured mesoporous material as claimed in any one of claims 1 to 10, characterized in that the suspension formed during step (A) also comprises an interaction agent.

12. The process for preparing an ordered or mesostructured mesoporous material as claimed in claim 11, characterized in that the colloidal particles used are of cerium oxide, zirconium oxide and/or titanium oxide type and in that said interaction agent is a mineral or organic acid.

13. The process for preparing an ordered or mesostructured mesoporous material as claimed in claim 12, characterized in that the templating agent is of modified poly(ethylene oxide) type and in that the (H⁺ ions)/(ethylene oxide monomers) molar ratio in the suspension is less than 0.3.

14. The process for preparing an ordered or mesostructured mesoporous material as claimed in any one of claims 1 to 13, characterized in that the suspension formed during step (A) is an aqueous suspension also containing a cosolvent.

15. The process for preparing an ordered or mesostructured mesoporous material as claimed in claim 14, characterized in that said cosolvent is chosen from methanol, ethanol, propanol and isopropanol.

16. The process for preparing an ordered or mesostructured mesoporous material as claimed in claim 14 or claim 15, characterized in that the cosolvent/water volume ratio in the suspension is less than or equal to 6.

17. The process for preparing an ordered or mesostructured mesoporous material as claimed in any one of claims 1 to 16, characterized in that the concentration step (B) is carried out by evaporation.

18. The process for preparing an ordered or mesostructured mesoporous material as claimed in claim 17, characterized in that said evaporation is carried out in a single step at a temperature of between 15° C. and 80° C., for a period of between 3 hours and 7 days.

19. The process for preparing an ordered or mesostructured mesoporous material as claimed in claim 17, characterized in that said evaporation is carried out in several steps with stages of increasing temperature of between 15° C. and 120° C., the duration of each of the stages being between 3 hours and 24 hours and the temperature increase steps possibly being carried out with a temperature increase gradient of between 0.1 and 6° C. per minute or by direct passage into a medium brought beforehand to the stage temperature.

20. The process for preparing an ordered or mesostructured mesoporous material as claimed in any of claims 1 to 19, characterized in that step (C) of removal of the templating agent is performed by entrainment with a solvent.

21. The process for preparing an ordered or mesostructured mesoporous material as claimed in any one of claims 1 to 20, characterized in that step (C) of removal of the templating agent is performed by a heat treatment of calcination type.

22. The process for preparing an ordered or mesostructured mesoporous material as claimed in claim 21, characterized in that said heat treatment of calcination type is carried out at a calcination temperature of greater than 200° C., with a rate of temperature increase of between 0.2° C. and 5° C. per minute, followed by a calcination stage at said calcination temperature lasting between 0.5 and 10 hours.

23. A heat-stable and at least partially crystalline ordered or mesostructured mesoporous material that may be prepared according to the process of any one of claims 1 to 22.

24. A partially crystalline and heat-stable ordered mesoporous or mesostructured material consisting essentially of a compound chosen from cerium oxide, zirconium oxide, titanium oxide and a mixture of these compounds, such as a mixture of CeO₂/ZrO₂ or ZrO₂/CeO₂ type.

25. The material as claimed in claim 23 or claim 24, characterized in that the degree of crystallinity of said material is greater than 20% by volume.

26. The material as claimed in claim 23 or claim 24, characterized in that the degree of crystallinity of said material is greater than 30% by volume.

27. The material as claimed in any one of claims 23 to 26, characterized in that the average thickness of the walls of the mesostructure of said material is between 2 and 40 nm.

28. The material as claimed in any one of claims 23 to 26, characterized in that the average thickness of the walls of the mesostructure of said material is between 3 and 15 nm.

29. The material as claimed in any one of claims 23 to 28, characterized in that the average thickness of the walls of the mesostructure of said material is between 4 and 10 nm.

30. The material as claimed in any one of claims 23 to 29, characterized in that, after calcination for 6 hours at 500° C., the specific surface area of said material is greater than 800 m²/cm³.

31. The material as claimed in any one of claims 23 to 30, characterized in that, after calcination for 6 hours at 500° C., the specific surface area of said material is greater than 1000 m²/cm³.

32. The material as claimed in any one of claims 23 to 31, characterized in that said material has at least one mesostructure chosen from:
mesoporous mesostructures of three-dimensional hexagonal symmetry P63/mmc, of two-dimensional hexagonal symmetry P6 mm, or of three-dimensional cubic symmetry la3d, lm3m or Pn3m;
mesostructures of vesicular or lamellar type; or
mesostructures of L3 symmetry, known as sponge phases.

33. The material as claimed in any one of claims 23 to 27, characterized in that it is an ordered mesoporous material and in that the pores observed within the mesostructure of said material are such that at least 50% of the population of the pores present in the structure has a mean diameter of between 2 and 10 nm.

34. The use of a material as claimed in any one of claims 23 to 31 for catalytic applications.

35. The use as claimed in claim 32 for catalytic applications in the field of motor vehicle depollution or the denitrification of effluents.
